(19) United States
(12) Patent Application Publication
(10) Pub. No.: US 2010/0214048 A1
(43) Pub. Date: Aug. 26, 2010

(54) INDUCTOR

(75) Inventors: M.H. LI, Dong-Guan City (CN); Sourr TAN, Dong-Guan City (CN); C.S. KUNG, Taoyuan Hsien (TW)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: DELTA ELECTRONICS, INC., Taoyuan Hsien (TW)

(21) Appl. No.: 12/504,304

(22) Filed: Jul. 16, 2009

(30) Foreign Application Priority Data
Feb. 26, 2009 (TW) 098202867

(51) Int. Cl. H01F 27/06; H01F 27/28

(52) U.S. Cl. 336/65

(57) ABSTRACT

An inductor adapted to be electrically connected to a printed circuit board is provided. The inductor comprises a shell, a columnar core and a base. The shell is adapted to define a through hole. The columnar core is adapted to be received in the through hole. The base has a supporting surface and a plurality of welding pins extending from the supporting surface. The columnar core is adapted to be disposed on the supporting surface and be received, along with the supporting surface, in the through hole. The welding pins are extended over the shell and are electrically connected to the printed circuit board.

This application claims priority to Taiwan Patent Application No. 098202867 filed on Feb. 26, 2009, the disclosure of which is incorporated by reference herein in its entirety.

### CROSS-REFERENCES TO RELATED APPLICATIONS

Not applicable.

### BACKGROUND OF THE INVENTION

1. Field of the Invention

The present invention relates to an inductor, and particularly, to an inductor for use in communication and power source equipment.

2. Descriptions of the Related Art

Inductors stabilize currents by filtering undesirable components in the current and reducing electromagnetic interference (EMI) possibly induced by current variations during the operation of electronic products, thereby keeping the operation performance of the electronic products consistent.

In reference to both FIGS. 1A and 1B for an inductor 100 used in the prior art, the inductor 100 comprises a shell 200, a columnar core 300 and a base 400. The shell 200 is formed with a through hole 210. The base 400 has two opposite surfaces, namely, a supporting surface 410 and a welding surface 420 opposite the supporting surface 410, and a plurality of winding pins 430. The welding surface 420 has a plurality of welding areas adjacent to each other disposed thereon. A plurality of winding pins 430 extends from the supporting surface 410. The columnar core 300 with a coil 310 wound thereon is disposed on the supporting surface 410 of the base 400. The winding pins 430 are adapted to cover the columnar core 300. Thus, the columnar core 300 and the base 400 are both adapted to be received in the through hole 210 so that the inductor 100 can be secured to a circuit board (not shown) by means of the plurality of welding areas on the welding surface 420.

However, since the base 400 of the inductor 100 of the prior art is received in the through hole 210, the distance between two adjacent welding areas on the welding surface 420 is restricted by the side length of the shell 200. This makes short-circuiting more likely to occur due to the closeness of the soldering tin between the welding areas during the welding process. Meanwhile, also due to the closeness of the soldering tin between the welding areas, the spacing between soldering points may become too short, which further degrades the stability of the inductor 100 that is soldered on the circuit board. Furthermore, when the inductor 100 is soldered to the circuit board, the minimum relative distance from the inductor 100 to other electronic components is just the side length of the shell 200, so unexpected electromagnetic interference tends to interfere with the normal operation of electronic components during the operation of the inductor 100.

In view of this, it is important to mitigate the electromagnetic interference between the inductor and other electronic components, as well as improving the welding stability of the inductor.

### SUMMARY OF THE INVENTION

One objective of the present invention is to provide an inductor which, by enlarging the distance between the welding pins of the inductor, prevents unexpected short-circuiting when the inductor is welded to a circuit board and enlarges the relative distances between the inductor and other electronic components of the circuit board, thereby mitigating electromagnetic interference there between.

Another objective of the present invention is to provide an inductor which, by enlarging the area of each welding pin of the inductor, reinforces the stability of the inductor soldered to a circuit board.

The inductor of the present invention comprises a shell, a columnar core and a base. The shell is adapted to define a through hole. The columnar core is adapted to be received in the through hole. The base has a supporting surface and a plurality of welding pins extending from the supporting surface, while the columnar core is adapted to be disposed on the supporting surface and to be received, along with the supporting surface, in the through hole. The welding pins extend outside the shell and are electrically connected to the printed circuit board.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is an exploded perspective view of an inductor in the prior art;

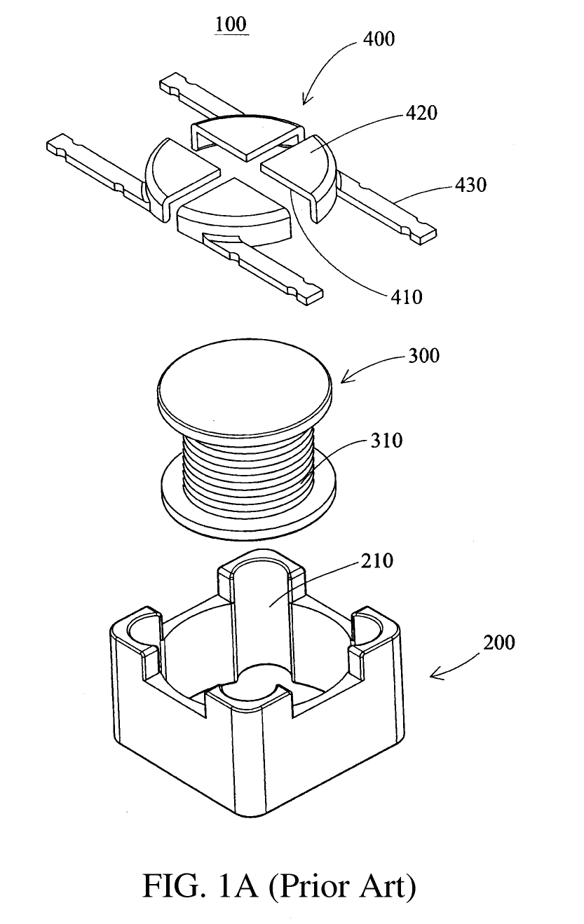

FIG. 1B is a perspective view of an inductor in the prior art;

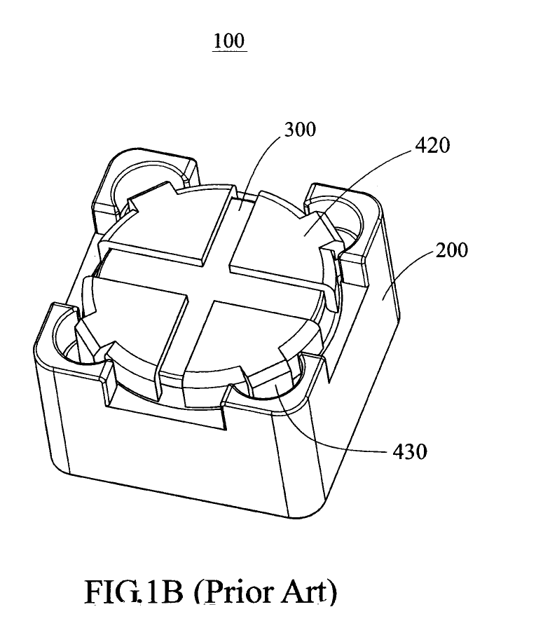

FIG. 2 is an exploded perspective view of an inductor in an embodiment of the present invention; and

FIG. 3 is a perspective view of an inductor in an embodiment of the present invention.

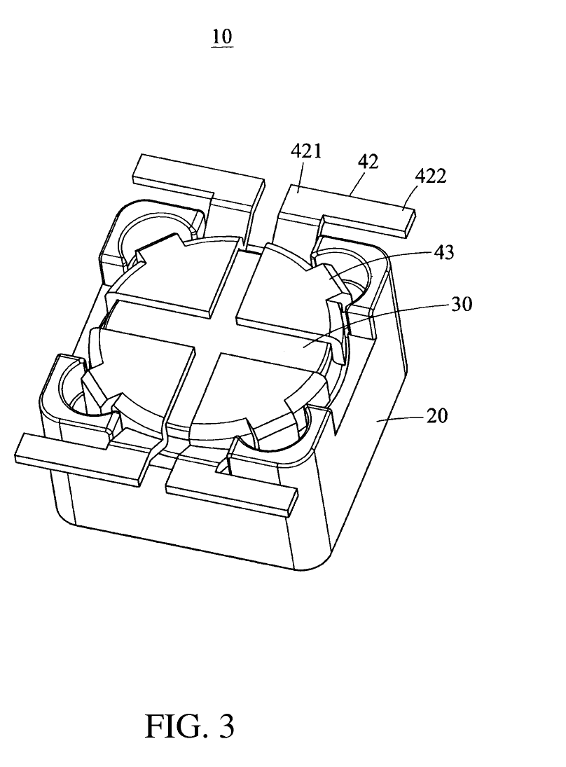

### DESCRIPTION OF THE PREFERRED EMBODIMENT

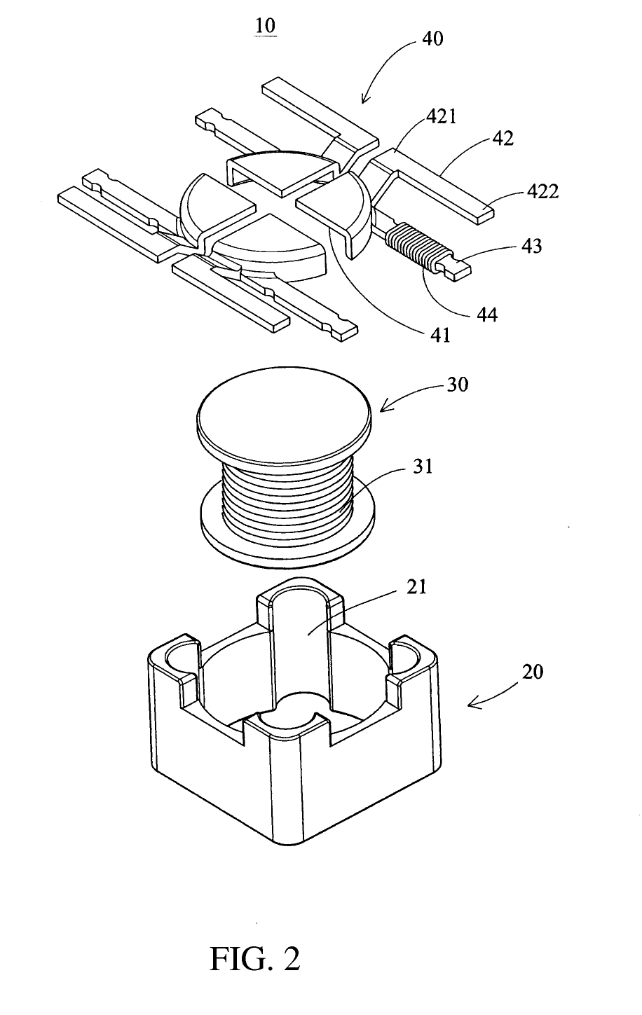

FIG. 2 illustrates a schematic view of an inductor 10 in an embodiment of the present invention. The inductor 10 of the present invention is electrically connected to a circuit board (not shown), and comprises a shell 20, a columnar core 30 and a base 40. The shell 20 is generally in the form of a ring, which is adapted to define a through hole 21. The columnar core 30, when having a coil 31 wound thereon, is adapted to be received in the through hole 21. The shell 20, which is preferably a rectangular hollow shell, helps to shield electromagnetic interference induced during the operation of other electronic components on the circuit board.

The base 40 comprises a supporting surface 41, a plurality of welding pins 42 extending from the supporting surface 41, and a plurality of winding pins 43 also directly extending from the supporting surface 41. When the columnar core 30 is disposed on the supporting surface 41, the plurality of winding pins 43 is adapted to be bent inwards by 90° towards the supporting surface 41 to cover the columnar core 30 so that the supporting surface 41, the columnar core 30 and the plurality of winding pins 43 can be received in the through hole 21 together. The inductor 10 further comprises a plurality of stranded wires 44 adapted to be wound around the winding pins 43. The plurality of winding pins 43 should preferably include four winding pins.

After the columnar core 30 is disposed on the supporting surface 41 and covered by the plurality of winding pins 43 such that the supporting surface 41, the columnar core 30 and the plurality of winding pins 43 are received in the through hole 21 together, the plurality of welding pins 42 is adapted to extend outside the shell 20 and electrically connect to the circuit board 50. The plurality of welding pins 42 should preferably include four welding pins, each of which has a root portion 421 and an end portion 422. Each of the root portions 421 extends directly from the supporting surface 41 and is adjacent to one of the winding pins 41 respectively.

To prevent short-circuiting due to the closeness between the welding pins 42 when welding the inductor 10 to a circuit board, every two adjacent end portions 422 of the welding pins 42 in the inductor 10 of the present invention is spaced at a distance greater than the side length of the shell 20. In other words, the distance between every two adjacent end portions 422 of the welding pins 42 extends beyond the shell 20 to enlarge the spacing between the welding pins 42. In the preferred embodiment, an optimal distance between every two adjacent end portions 422 is 5 millimeters. In this way, short-circuiting during the welding process is reduced because of the increased distance between welding pins. In addition, due to the increased distance between welding pins 42, the relative distance between the inductor 10 and other electronic components is also increased, thereby mitigating the electromagnetic interference therebetween. On the other hand, because the spacing between the welding pins 42 of the present invention is greater than those in traditional cases, the area of the welding pins 42, especially the area of the end portions 422, is enlarged in the present invention, which is substantially beneficial to the stability of the inductor 10 fixed on the circuit board.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An inductor adapted to be electrically connected to a printed circuit board, comprising:
a shell, adapted to define a through hole;
a columnar core, adapted to be received in the through hole; and
a base, having a supporting surface and a plurality of welding pins extended from the supporting surface, the columnar core being adapted to be disposed on the supporting surface and to be received in the through hole together with the supporting surface,
wherein the welding pins are extended over the shell and are electrically connected to the printed circuit board.

2. The inductor of claim 1, wherein the base further comprises a plurality of winding pins, the winding pins are extended from the supporting surface directly.

3. The inductor of claim 2, wherein the winding pins comprises 4 winding pins.

4. The inductor of claim 2, wherein after the columnar core is disposed on the supporting surface, the columnar core is adapted to be wrapped by the winding pins, and to be received in the through hole together with the winding pins.

5. The inductor of claim 2, further comprising a plurality of stranded wire, adapted to be wound around the winding pins.

6. The inductor of claim 1, further comprising a coil, adapted to be wound around the columnar core.

7. The inductor of claim 3, wherein the welding pins comprises 4 welding pins, each of the welding pins has a root portion and an end portion, each of the root portion is directly extended from the supporting surface, respectively, and is adjacent to one of the winding pins.

8. The inductor of claim 7, wherein a distance of two adjacent end portions of the welding pins is greater than a side length of the shell.

9. The inductor of claim 8, wherein the distance of the two adjacent end portions is 5 mm.

10. The inductor of claim 1, wherein the shell is a square shell.
